(19) United States
(12) Patent Application Publication
(10) Pub. No.: US 2018/0290596 A1
(43) Pub. Date: Oct. 11, 2018

(54) EXTENDABLE ARTICULATING LADDER

(71) Applicant: GM GLOBAL TECHNOLOGY OPERATIONS LLC, Detroit, MI (US)

(72) Inventors: Celso K. Fukushima, Sao Paulo (BR); Fabio L. Costa, Rochester Hills, MI (US); Sergio R. Espada, Rochester Hills, MI (US)

(73) Assignee: GM GLOBAL TECHNOLOGY OPERATIONS LLC, Detroit, MI (US)

(21) Appl. No.: 15/484,528

(22) Filed: Apr. 11, 2017

(51) Int. Cl. B60R 3/02; B60R 9/042

(52) U.S. Cl. CPC B60R 3/02; B60R 9/0423

(57) ABSTRACT

A scaffolding or extendable ladder mechanism is attachable to a rack elevated from a base level. The scaffolding includes a housing fixedly attached to the rack, and a rail mechanism slidably attached to the housing. The rail mechanism is movable between a stowed position and a deployed position. A ladder is movably attached to the rail mechanism, and is slidable and rotatable relative to the rail mechanism. The ladder is movable between a retracted position, substantially within the rail mechanism, and an extended position, substantially outside of the rail mechanism. The extended position of the ladder is also rotated relative to the rail mechanism, and the ladder is nearer the base level in the extended position than in the retracted position.

### INTRODUCTION

This disclosure generally relates to scaffolding or ladder mechanisms. In particular, the disclosure relates to a scaffolding assembly that is retractable to stow out of the way when not in use.

### SUMMARY

A scaffolding or extendable ladder mechanism is provided. The scaffolding is attachable to a rack elevated from a base level, such as the ground or a floor surface. The scaffolding includes a housing fixedly attached to the rack and a rail mechanism slidably attached to the housing.

The rail mechanism is movable between a stowed position and a deployed position. A ladder is movably attached to the rail mechanism, and is slidable and rotatable relative to the rail mechanism.

The ladder is movable between a retracted position, substantially within the rail mechanism, and an extended position, substantially outside of the rail mechanism. The extended position of the ladder is also rotated relative to the rail mechanism, and the ladder is nearer the base level in the extended position than in the retracted position.

In some configurations of the scaffolding, the ladder includes an upper ladder slidably and rotatably attached to the rail mechanism and a lower ladder slidably attached to the upper ladder. The lower ladder is distal to the rail mechanism and is configured to contact the base level when the ladder is in the extended position.

In some configurations, the scaffolding includes one or more locks. A first lock may selectively prevent movement of the rail mechanism from the stowed position to the deployed position and from the deployed position to the stowed position. A second lock may selectively prevent movement of the upper ladder from the extended position to the retracted position.

In some configurations of the scaffolding, the upper ladder rotates about the rail mechanism at a pivot point, which is distal to the housing when the rail mechanism is in the deployed position. Furthermore, the extended position of the ladder may not occupy any of the same space as the retracted position of the ladder.

The above features and advantages, and other features and advantages, of the present subject matter are readily apparent from the following detailed description of some of the best modes and other embodiments for carrying out the disclosed structures, methods, or both.

### BRIEF DESCRIPTION OF THE DRAWINGS

FIG. 1 is a schematic isometric view of a ladder assembly attached to a rack, such as may be incorporated into vehicle or other elevated structures, with the ladder assembly shown substantially stowed.

FIG. 2 is a schematic rear view of the ladder assembly and rack mounted to a sport utility vehicle, and shown substantially deployed.

FIG. 3 is a schematic isometric view of the ladder assembly and rack, illustrating a rail mechanism deployed from a housing.

FIG. 4 is a schematic detail view illustrating operation of a first lock mechanism.

FIG. 5 is a schematic detail view of a portion of the ladder assembly and rack, illustrating the ladder extending from the rail mechanism and engaging a second lock mechanism.

FIG. 6 is a schematic isometric view of the ladder assembly and rack, illustrating the ladder rotating relative to the rail mechanism and lowering toward the base level.

FIG. 7 is a schematic isometric view of the ladder assembly and rack deployed in the opposite direction to that shown in FIGS. 1-3 and 5-6, illustrating a lower ladder extending downward from an upper ladder to the base level.

### DETAILED DESCRIPTION

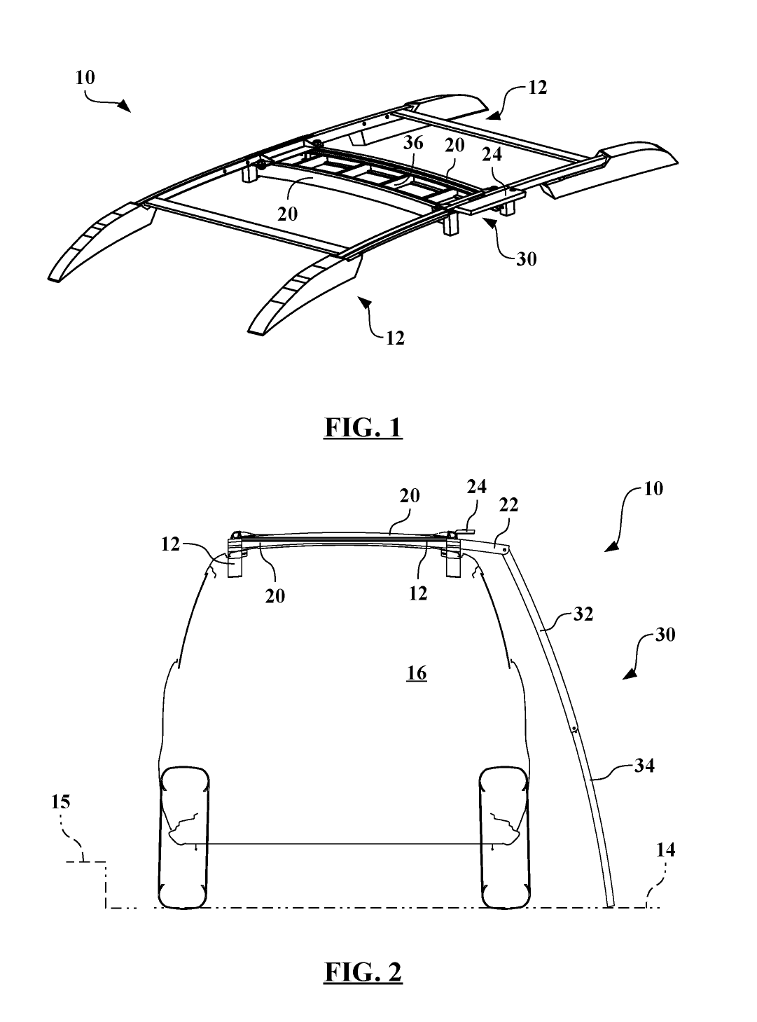

In the drawings, like reference numbers correspond to like or similar components whenever possible throughout the several figures. There are shown in FIG. 1 and FIG. 2 schematic views of a ladder assembly or scaffolding 10.

The scaffolding 10 is attachable to a rack 12 that is elevated or offset from a base level 14, which may be, for example, the ground, a road surface, or a floor surface. As shown in the figures, the scaffolding 10 is selectively deployable, in one or more directions, to facilitate access to the rack 12 or to associated structures and areas. Portions of the rack 12, or components attached thereto, may not be otherwise reachable by someone at or near the base level 14. Full or partial deployment of the scaffolding 10 is illustrated in at least FIGS. 2, 6, and 7, and will be explained in greater detail herein.

FIG. 1 shows the scaffolding 10 substantially stowed and FIG. 2 shows the scaffolding 10 attached to a vehicle 16. In FIG. 2, the vehicle 16 is illustrated schematically, and viewed from the rear, as a sport utility vehicle. However, other vehicle, and non-vehicle, configurations exist for the scaffolding 10.

While the present disclosure may be described with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

In some configurations, as schematically illustrated in FIG. 2, the rack 12 may be mounted to the top of the vehicle 16. In such a configuration, the base level 14 may be a road surface. The rack 12 may be referred to as a roof rack, cargo rack, or utility rack. The rack 12 shown includes both longitudinal and transverse members that are offset slightly from the roof of the vehicle 16. In other configurations, the structure of the rack 12 may be built into the vehicle 16, such that the scaffolding 10 is attached directly to the roof of the vehicle 16, without additional structural elements.

The associated vehicle, and any components incorporated therewith, may be representative of numerous types of vehicles, including planes, trains, automobiles, or any other rolling or movable platform. Additionally, heavy industrial, construction, and mining equipment may incorporate features of the scaffolding 10 described herein. The scaffolding 10 may also be incorporated into other structures, such as within residential, commercial, or industrial buildings.

As used herein, elevated refers to the usual orientation of the rack 12 relative to the base level 14, such as at the top of the vehicle 16 during normal operation. The shape of the base level 14 may vary greatly, such that some positions are higher than others. However, under most operating conditions, the base level 14 will be below, relative to gravity, the top of the vehicle 16, the rack 12, and the stowed scaffolding 10.

The scaffolding 10 deploys to provide an operator of the vehicle 16 improved access to the rack 12 and the top of the vehicle 16. For example, roof-mounted luggage boxes or sporting equipment may be difficult to load or manipulate while mounted to the rack 12. However, the improved position provided by the deployed scaffolding 10 may assist the operator in dealing with, for example, bicycles or kayaks stored on the rack 12.

Note that the rack 12 is also representative of other, non-vehicular, structures that may utilize the scaffolding 10. For example, the scaffolding 10 may be mounted to structures adjacent an elevated door to a home or business attic, or within the eaves of a garage to provide improved access to overhead storage. In such a configuration, the rack 12 may be formed from truss boards or girders.

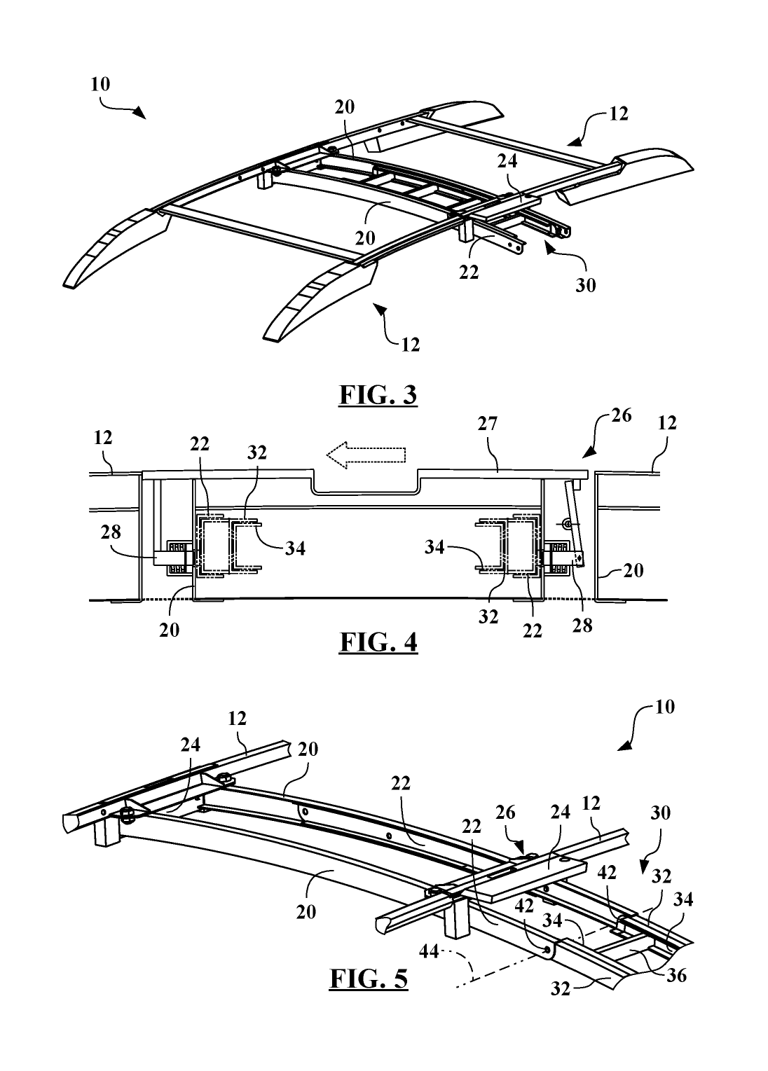

Referring also to FIG. 3, FIG. 4, and FIG. 5, and with continued reference to FIGS. 1-2, there are shown additional views illustrating operation of the scaffolding 10. The scaffolding 10 includes a housing 20, which is fixedly attached to the rack 12 or other supportive structures. As shown in the figures, when the scaffolding 10 is installed to a vehicle 16, the housing 20 may be transversely oriented and attached between longitudinal members.

A rail mechanism 22 is slidably attached to the housing 20. The rail mechanism 22 is movable between at least a stowed position (illustrated in FIG. 1) and a deployed position (illustrated in FIGS. 2-3 and 5-7).

In many configurations, the stowed position of the rail mechanism 22 is entirely within the housing 20, but may also extend partially from the housing 20. FIG. 3 shows the rail mechanism moved, relative to FIG. 1, from the stowed position to the deployed position, which is at least partially distal to the housing 20.

As shown in FIGS. 1 and 3, a door 24 may be opened to allow the rail mechanism to move to the deployed position. There may be door 24 on each side of the scaffolding 10, and each of the doors 24 may be open or released via a key lock, as shown in the figures. The doors 24 generally act as a barrier to accidental deployment of the scaffolding 10, and may be unlocked with the same key used to operate the vehicle 16 or with another specific key.

FIG. 4 shows a schematic illustration of a first lock or rail lock 26 of the scaffolding 10. The rail lock 26 selectively prevents movement of the rail mechanism 22 from the stowed position to the deployed position. The rail lock 26 is stowed within the rack 12, housing 20, or a combination thereof.

As illustrated in FIG. 5, the rail lock 26 also prevents movement of the rail mechanism and from the deployed position to the stowed position, and of the rail mechanism beyond the deployed position. Therefore, the rail lock 26 also prevents over-extension of the rail mechanism 22.

In the configuration shown in FIG. 4, movement of a slider 27 (leftward, as viewed in the figure) of the rail lock 26 unlocks or retracts one or more pins or plungers 28 that otherwise prevent movement of the rail mechanism 22. Once released, as shown, the rail mechanism 22 is free to move to or from the stowed position. Note that other locking mechanisms may be used, and the configuration of the rail lock 26 shown is only illustrative.

The plungers 28 may be spring biased, such that they, and the slider 27, return to a locked position (rightward of that shown in FIG. 4) once able. Therefore, the rail lock 26 is released to allow the rail mechanism 22 to move from the stowed position, and then re-engages to hold the rail mechanism 22 in the deployed position, and functions similarly in reverse.

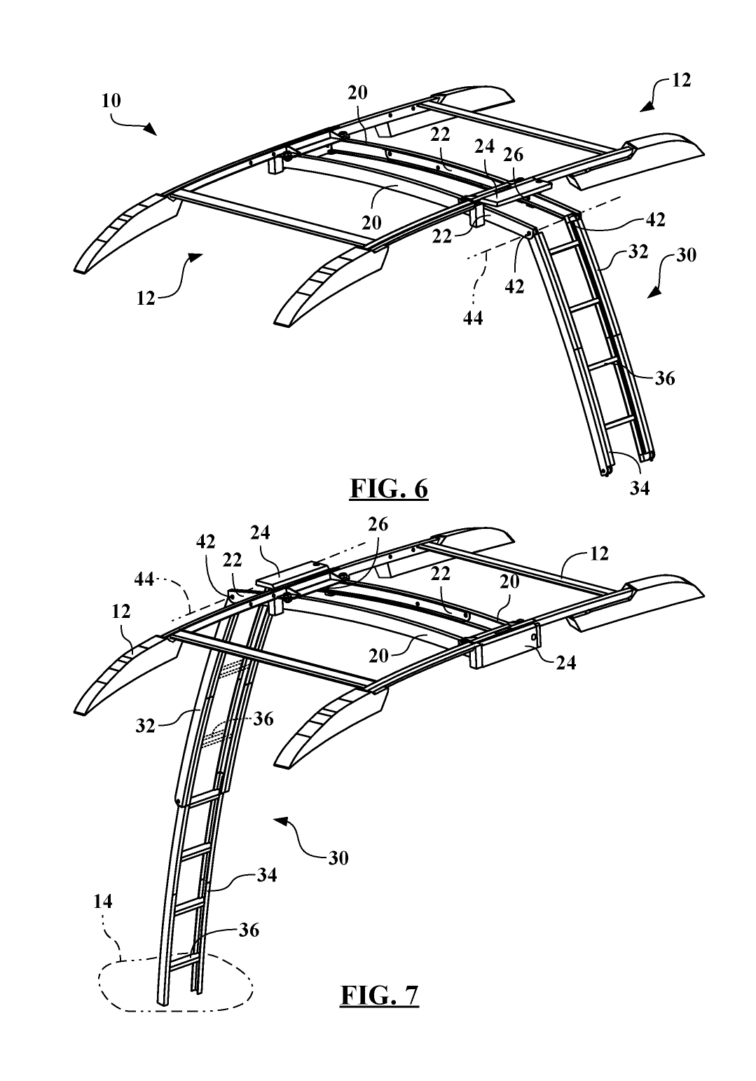

Referring also to FIG. 6 and FIG. 7, and with continued reference to FIGS. 1-5, there are shown additional views of the scaffolding 10 in deployed positions. As shown in the figures, a ladder 30 is movably attached to the rail mechanism 22.

The ladder 30 is slidable and rotatable relative to the rail mechanism 22, to move between at least a retracted position (shown in FIGS. 1 and 3) and an extended position (shown in FIGS. 2 and 5-7). In particular, FIG. 5 shows the ladder 30 extended from the rail mechanism 22, and FIG. 6 shows the ladder 30 rotated (downward, toward the base level 14) relative to the rail mechanism 22.

In the configuration shown, the retracted position of the ladder 30 is entirely within, or surrounded by, the rail mechanism 22. Some configurations may have the ladder 30 partially extending from the rail mechanism 22 or substantially within the rail mechanism 22. The extended position is substantially outside of the rail mechanism 22 and is rotated relative to the rail mechanism 22. Therefore, the ladder 30 is nearer the base level 14 in the extended position than in the retracted position.

FIG. 6 shows the ladder 30 extended only partially toward the base level 14. This may be the final position of the ladder 30, such that the operator reaches upward from the base level 14 to access the ladder 30. However, the ladder 30 may also extend further.

As shown in FIG. 7, the scaffolding 10 may be configured with the ladder 30 having both an upper ladder 32 and a lower ladder 34. The upper ladder 32 is slidably and rotatably attached to the rail mechanism 22, and the lower ladder 34 slidably attached to the upper ladder 32, such that the lower ladder 34 extends from the upper ladder 32. Therefore, the lower ladder 34 may extend to be distal to the rail mechanism 22 and to contact, or move very near, the base level 14 when the ladder 30 is in the extended position.

In some configurations of the scaffolding 10, the lower ladder 34 may be adjustable—by sliding within, and relative to, the upper ladder 32—such that the ladder 30 contacts varying heights of the base level 14 relative to the vehicle 16. For example, if the vehicle 16 is parked next to an embankment or a curb 15 (as shown schematically in FIG. 2), a portion of the lower ladder 34 may stay within the upper ladder 32 to account for the higher contact point. The ladder 30 may also be configured such that the lower ladder 34 hovers just above the base level 14. These configurations allow the scaffolding 10 to adjust to myriad situations, while still providing improved access to the rack 12 and the top of the vehicle 16.

One or more rungs 36 are formed on at least the lower ladder 34, as shown in FIGS. 1, 3, and 5-7. Additional, or upper, rungs 36 may also be formed on the upper ladder 32, as illustrated with dashed lines in FIG. 7, particularly where the ladder 30 is configured to extend over relatively large heights or distances.

In some configurations of the scaffolding 10, a second lock or ladder lock 42 may be operatively attached between the ladder 30 and the rail mechanism 22. As partially viewed in FIG. 5, the ladder lock 42 selectively prevents movement of the upper ladder 32 beyond, relative to the rail mechanism 22, the extended position.

The ladder lock 42 may utilize spring-loaded pins (not shown) or other selectively engaged structures. Additionally, the ladder lock 42 may prevent movement of the ladder 30 from the extended position to the retracted position, such that the ladder lock 42 is disengaged before stowing the scaffolding 10.

In the configuration of the scaffolding 10 shown, the upper ladder 32 rotates about the rail mechanism 22 at an axis or a pivot point 44. The pivot point 44 is distal to the housing 20 when the rail mechanism 22 is in the deployed position.

In the configuration shown, the pivot point 44 is substantially aligned with the ladder lock 42, such that both mechanisms may be incorporated into shared structure. However, the ladder lock 42 and pivot point 44 may be achieved via separate structures or components.

Note that as the scaffolding 10 deploys, particularly as shown in FIGS. 2, 6, and 7, the extended position of the ladder 30 does not occupy any of the same space as the fully stowed position of the ladder 30. The rail mechanism 22 allows the ladder 30 to be distal from its stowed location, which creates extra space for people, cargo, or actuation of doors relative to the ladder 30.

As shown in FIGS. 6 and 7, the scaffolding 10 may be actuated in two different directions. The extended position of the ladder 30 shown in FIG. 6 (and also in FIG. 2) may be referred to as a first extended position, such that the upper ladder 32 and the lower ladder 34 are distal to a first side of the housing 20 and of the rack 12. FIG. 2, which shows the vehicle 16 from the front, and FIG. 6 illustrate actuation of the scaffolding to the first side. However, as shown in FIG. 7, the ladder 30 is configured to move to a second extended position, such that the upper ladder 32 and the lower ladder 34 are distal to a second side of the housing 20 and the rack 12, opposite the first side.

Actuation of the scaffolding 10 to the second side of the rack 12 may occur through similar, or mirrored componentry. For example, another door 24 may prevent access to the rail mechanism 22 from the second side. Similarly, another rail lock 26 and another ladder lock 42 may control and limit movement of the rail mechanism 22 to the deployed position and the ladder 30 to the extended position, respectively.

This feature allows access to the rack 12 from either side of the vehicle 16. For example, as partially illustrated in FIG. 2, the curb 15 may be rough or unstable, such that it is more beneficial to extend the scaffolding 10 in the first direction (leftward, as viewed in FIG. 2) on the opposing side of the vehicle 16 from the curb 15. Alternatively, the side having the curb 15 (rightward, as viewed in FIG. 2) may provide better access to cargo or sporting equipment on the rack 12, such that the scaffolding 10 preferably extends in the second direction (as also shown in FIG. 7).

The detailed description and the drawings or figures are supportive and descriptive of the subject matter discussed herein. While some of the best modes and other embodiments for have been described in detail, various alternative designs, configurations, and embodiments exist.

1. A scaffolding attachable to a rack elevated from a base level, comprising:
a housing fixedly attached to the rack;
a rail mechanism slidably attached to the housing, wherein the rail mechanism is movable between a stowed position and a deployed position; and
a ladder movably attached to the rail mechanism, wherein the ladder is slidable and rotatable relative to the rail mechanism between:
a retracted position, substantially within the rail mechanism; and
an extended position substantially outside of the rail mechanism and rotated relative to the rail mechanism, wherein the ladder is nearer the base level in the extended position than in the retracted position.

2. The scaffolding of claim 1, wherein the ladder includes:
an upper ladder slidably and rotatably attached to the rail mechanism; and
a lower ladder slidably attached to the upper ladder, wherein the lower ladder is distal to the rail mechanism and is configured to contact the base level when the ladder is in the extended position.

3. The scaffolding of claim 2, further comprising:
a first lock selectively preventing movement of the rail mechanism from the stowed position to the deployed position and from the deployed position to the stowed position.

4. The scaffolding of claim 3, further comprising:
a second lock selectively preventing movement of the upper ladder from the extended position to the retracted position.

5. The scaffolding of claim 4,
wherein the upper ladder rotates about the rail mechanism at a pivot point, and
wherein the pivot point is distal to the housing when the rail mechanism is in the deployed position.

6. The scaffolding of claim 5,
wherein the extended position of the ladder does not occupy any of a same space as the retracted position of the ladder.

7. The scaffolding of claim 6,
wherein the extended position of the ladder is a first extended position, such that the upper ladder and the lower ladder are distal to a first side of the housing and the rack, and
wherein the ladder is configured to move to a second extended position, such that the upper ladder and the lower ladder are distal to a second side of the housing and the rack, opposite the first side.

8. The scaffolding of claim 1, further comprising:
a first lock selectively preventing movement of the rail mechanism from the stowed position to the deployed position and from the deployed position to the stowed position.

9. The scaffolding of claim 8,
wherein the ladder rotates about the rail mechanism at a pivot point, and
wherein the pivot point is distal to the housing when the rail mechanism is in the deployed position.

10. A vehicle configured to sit on a base level, comprising:
a rack attached to the vehicle opposite the base level;
a housing fixedly attached to the rack;
a rail mechanism slidably attached to the housing, and having a pivot point defined on one end thereof, wherein the rail mechanism is slidable, relative to the housing, between:
a stowed position, substantially within the housing; and
a deployed position, in which the pivot point is distal to the housing; and
a ladder mechanism movably attached to the rail mechanism, wherein the ladder mechanism is slidable and rotatable relative to the rail mechanism between:
a retracted position, substantially within the rail mechanism; and
an extended position substantially outside of the rail mechanism and rotated relative to the rail mechanism, wherein the ladder mechanism is nearer the base level in the extended position than in the retracted position.

11. The vehicle of claim 10,
wherein the ladder mechanism rotates about the rail mechanism at the pivot point,
wherein the pivot point is distal to the housing when the rail mechanism is in the deployed position, and
wherein the extended position of the ladder mechanism does not occupy any of a same space as the retracted position of the ladder mechanism.

12. The vehicle of claim 11, further comprising:
a first lock selectively preventing movement of the rail mechanism from the stowed position to the deployed position and from the deployed position to the stowed position; and
a second lock selectively preventing movement of the ladder mechanism from the extended position to the retracted position.

13. The vehicle of claim 12, wherein the ladder mechanism includes:
an upper ladder slidably attached to the rail mechanism and rotatable about the pivot point; and
a lower ladder slidably attached to the upper ladder, wherein the lower ladder is distal to the rail mechanism and configured to contact the base level when the ladder is in the extended position.

14. The vehicle of claim 13,
wherein the extended position of the ladder mechanism is a first extended position, such that the upper ladder and the lower ladder are distal to a first side of the vehicle, and
wherein the ladder mechanism is configured to move to a second extended position, such that the upper ladder and the lower ladder are distal to a second side of the vehicle, opposite the first side.
